(19) United States
(12) Patent Application Publication
(10) Pub. No.: US 2002/0128871 A1
(43) Pub. Date: Sep. 12, 2002

(54) Method, apparatus, and system for aggregating, targeting, and synchronizing health information delivery

(76) Inventors: Dan Adamson, San Francisco, CA (US); Eliot Weitz, San Francisco, CA (US); Leo Shih, East Palo Alto, CA (US); Alain T. Rappaport, San Mateo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/012,058

(22) Filed: Dec. 5, 2001

Related U.S. Application Data
(60) Provisional application No. 60/251,922, filed on Dec. 7, 2000.

(51) Int. Cl. G06F 17/60

(52) U.S. Cl. 705/3

(57) ABSTRACT

According to one aspect of the present invention, a method is provided in which a request is submitted to a first node in a network containing multiple nodes, the request containing data relating to a healthcare event associated with a patient. The request is processed at the first node to obtain information from one or more databases associated with the first node, based upon the data contained in the request. The request is also processed at one or more additional nodes in the network to obtain information from one or more additional databases associated with the one or more additional nodes, based upon the data contained in the request. A response to the request is generated based upon an aggregation of information obtained from the first node and the one or more additional nodes.

### RELATED APPLICATIONS

This application claims the benefit of U.S. Provisional Application No. 60/251,922, filed Dec. 7, 2000. This application is also related to U.S. patent application Ser. No. 09/591,769, filed Jun. 12, 2000.

### FIELD OF THE INVENTION

The present invention relates generally to the field of information processing. More specifically, the present invention relates to a method, apparatus, system, and machine-readable medium for aggregating, targeting, and synchronizing health information delivery.

### BACKGROUND

The healthcare industry is undergoing a fundamental transformation. Insurers, providers and hospital networks, clinical laboratories, pharmacies, manufacturers and other partners in the healthcare delivery chain are all adopting new consumer- and provider-centric business strategies. To support the execution of these strategies, a key requirement across the industry is to control and manage the flow of information between multiple sources, as well as synchronize it with the flow of services.

Healthcare is a highly information-intensive industry. Yet, its information distribution chains are increasingly broken by the impacts of economic pressures, the technical fragmentations and the lack of efficient infrastructures. HMOs, PPOs and other payers have significant difficulties reaching out to consumers in a targeted way. Intervention or health management programs that are well known to lower costs of care may be shelved on their way to the patients. Current industry portals are not efficient since the information is not targeted or coupled with consumers'healthcare events or episodes. Targeted information distribution is also increasingly critical to clinical laboratories and other service providers. It allows them to define new products, contribute further to health management and brand their services. Hospital networks are concerned with issues such as information flow, patient education, physician practice guidelines, and branding. Pharmacies, distributors, pharmaceutical and biotechnology companies also look at increasing high quality communications with consumers and physicians. In addition, for the target constituencies, such as patients and providers, Internet-based information resources are difficult to find, search and assess. New molecular medicine and genomics information reside in disparate databases and are increasingly important for both research and clinical activities, requiring powerful infrastructures to collate or aggregate the right information, from genes to disease. The number of healthcare transactions, from encounters to prescriptions or laboratory test orders, are all increasing, widening the information and management efficiency gap between the partners in the healthcare delivery chain. Addressing this need has become a key imperative for industry partners.

In general, some of the challenges of information delivery from the perspectives of different entities or partners in the healthcare delivery chain are discussed below:

### Insurer/Payer Challenges

Health insurance companies are actively engaged in broad and comprehensive strategies to reach out to consumers. They are setting up their own Internet strategies and portals for business functions ranging from claims processing to e-commerce and wellness information. A key challenge is to decrease costs of care and increase quality of service through information solutions that are tightly coupled with the health services.

There is a close business connection between controlling costs and improving member and provider relations. Better information leads, as is well known, to better compliance, higher enrollment in programs, better use of services, lower costs of care for both acute and chronic episodes, and other benefits.

Marketing and distribution costs of intervention programs are high, and existing communication channels are inefficient. Industry-led portals can reduce this cost, but are required to target the customer, physician or patient, very precisely. The highest added-value is not in passively posting information but actively delivering targeted and individualized, clinically relevant information.

Information about specific conditions provided in a timely and/or relevant manner to consumer members can have significant impact, including, but not limited to:

increase the quality of compliance with treatments and guidelines

decrease subsequent visits

increase preventative visits

decrease the misuse of emergency services

increase general patient education

improve disease management

improve short and long-term outcomes

The use of in-house disease management programs is a key direction for health plans, allowing for primary-care based disease management and cost containment. Hence the search for elegant and powerful solutions to address these key communications and content problems. Communications with providers is also essential. The effective distribution of outcomes research, disease management protocols and other clinical information is one of the key business imperatives. Non-clinical information, such as referral policies, may also need to be transmitted effectively to have their short and long-term economic benefits realized.

### Clinical Laboratories Challenges

Clinical Laboratories are an essential part of the healthcare value chain, providing services that critically affect care in more than half of all healthcare episodes. Increasingly, laboratories are faced with the need to shift from being simply results providers to being information provider, assisting health providers in the clinical management of lab results, and patients in the understanding and management of their conditions. Information products associated with the delivery of test results and other data are critical not only for routine tests but also for the increasing number and fast growing area of esoteric tests incorporating technology from molecular and genomic medicine. The quality of information and education provided to both consumers and physicians has become an essential asset in branding and long-term successes. Clinical laboratories are active participants in the healthcare delivery chain, beyond providing results.

### Distributors/PBMs Challenges

The distributors of healthcare products are another essential partner in the healthcare delivery chain. However, regardless of whether the healthcare products are purchased on-line or not, distributors are already in the next phase of providing, using the Internet, not just a transaction vehicle but an efficient information experience that will contribute to the quality of care.

The challenge for large distributors such as pharmacies is to create higher value-added experiences through their Internet presence, beyond streamlining the ordering process. However, automating the targeted delivery of these information and programs is a major challenge. Providing such information in a targeted way and integrated with information from other players in the prescription process (e.g., provider, insurer, pharmaceutical company, etc.) is an important and critical challenge facing the current drug retail e-commerce sector.

### Pharmaceuticals/Biotechnology Challenges

In addition, it is increasingly critical for pharmaceutical companies to provide high quality drug and drug-related information to both consumers and physicians or other providers. Clinical and scientific information needs to be distributed as-needed to all prescribers and patients. In addition to traditional prescription information, drug alerts, safety and prescription information, reflex algorithms, clinical trials and other related information have to be communicated to optimize the management of healthcare interactions in which the drugs are used or to be used.

The new areas of pharmacogenomics, genotyping, and other molecular profiling technologies are creating new types of tests, drugs and other products that increasingly require sophisticated management and monitoring of molecular events. Managing this information is a challenging process, requiring information from genome data, test and drug manufacturers, clinical databases and other sources.

### Physicians Challenges: the Information Last Mile

Physicians and other healthcare providers are increasingly using the Internet. According to various research, their main preoccupation is to access clinically pertinent data. From the progress of molecular medicine and genomics to the wealth of clinical studies published nowadays and the emergence of new guidelines and outcomes research in virtually all areas of clinical practice, medicine has become an information-intensive activity. However, staying up-to-date has become a major challenge for today's physicians. Researching the clinical or scientific literature takes a very significant amount of time. The same is true of obtaining the latest guidelines for specific problems encountered in practice. In essence, healthcare providers are experiencing an information “last mile” problem.

### Patients Challenges: the Information Last Mile

Consumers are a transforming force in the healthcare industry. Business strategies of healthcare partners and entities are increasingly consumer-centric, and patient empowerment entails a range of Internet-based services, from medical information to defined-contribution plans and increased connectivity with health plans. In spite of the apparent power of the Internet, one of the key concerns for consumers is to be better informed about their own health. As opposed to general news, healthcare may only be really interesting when and if it pertains to one's or a relative's well-being. However, many patients do not know what their condition really is, why a certain drug has been prescribed and how to manage their illness, condition or treatment. This may lead to misuse of medical services and other downstream problems as well as increased costs of care due to lack of information and proper management.

Accordingly, there exists a need for a method and system to facilitate the targeting, aggregating, and synchronizing of health information delivery.

### SUMMARY OF THE INVENTION

According to one aspect of the present invention, a method is provided in which a request is submitted to a first node in a network containing multiple nodes, the request containing data relating to a healthcare event associated with a patient. The request is processed at the first node to obtain information from one or more databases associated with the first node, based upon the data contained in the request. The request is also processed at one or more additional nodes in the network to obtain information from one or more additional databases associated with the one or more additional nodes, based upon the data contained in the request. A response to the request is generated based upon an aggregation of information obtained from the first node and the one or more additional nodes.

### BRIEF DESCRIPTIONS OF THE DRAWINGS

The features of the present invention will be more fully understood by reference to the accompanying drawings, in which:

FIG. 1 illustrates a block diagram of one embodiment of a system in which various entities in the healthcare delivery chain can be connected to provide and obtain relevant healthcare information;

FIG. 2 shows an example of various types of information and their potential sources that may be of interest to healthcare consumers (e.g., patients);

FIG. 3 illustrates an example of various types of information and their potential sources that may be of interest to healthcare providers (e.g., physicians);

FIG. 4 shows a block diagram of a network containing multiple nodes according to one embodiment of the present invention;

FIG. 5 illustrates a more detailed block diagram of a system in accordance with one embodiment of the present invention;

FIG. 6 shows a block diagram illustrating pathways of a request and a response according to the teachings of the present invention;

FIG. 7 shows a block diagram of a network node structure in accordance with one embodiment of the present invention;

FIG. 8 illustrates a block diagram showing interactions between various components in processing a request to generate a corresponding response, according to the teachings of the present invention;

FIG. 9 shows a flow diagram of process according to one embodiment of the present invention;

FIG. 10 is a flow diagram of one embodiment of a method according to the teachings of the present invention; and

FIG. 11 is a flow diagram of one embodiment of a method in accordance with the teachings of the present invention.

### DETAILED DESCRIPTION

In the following detailed description numerous specific details are set forth in order to provide a thorough understanding of the present invention. However, it will be appreciated by one skilled in the art that the present invention may be understood and practiced without these specific details.

According to the teachings of the present invention, a network or system as described in more details below is developed (also called the Medstory network or Medstory system herein) to address the problem of efficient and targeted information distribution between the various parties. The Medstory network is designed to create a network of existing and future interoperable sources that provide critical information directly associated with the management and delivery of consumer and professional services. In one embodiment, it can be configured to leverage database-intensive applications and integrate with existing and emerging business operations infrastructures. It can be independent of the delivery vehicle, which may include web, wireless, phone or television portals, etc. The customers or users of the Medstory network or system may include large healthcare industry companies such as insurers, clinical laboratories, distributors and physician or hospital networks developing their own portals or partnering with others to develop them, etc. They may also include pharmaceutical and biotechnology companies, bioinformatics, medical informatics and e-health or information technology service companies who can benefit from the healthcare information service and distribution.

In one embodiment, the network or network application according to the teachings of the present invention may be viewed as an information exchange infrastructure creating an information supply chain and automatically generating information products related to health services transactions or requests. The network may thus be tightly coupled to legacy systems, e-commerce infrastructures or other systems recording a clinical or biomedical event.

In one embodiment, the information exchange function or infrastructure may rely on a database application that determines the nature of the information and content appropriate to deliver independently or in conjunction with other traditional information, such as explanations of benefits or insurance claim reports, laboratory test results and prescriptions, etc. Some of the techniques used for information gathering, organization, and retrieval in the Medstory network/system are described in patent application Ser. No. 09/591,769 filed Jun. 12, 2000, entitled “Method, Apparatus, and System for Providing Health Information”, which claims the benefit of U.S. Provisional Application No. 60/140,102 filed Jun. 18, 1999.

In one embodiment, the Medstory network is configured to allow various users or entities connected to the network to pull together automatically and in a context-sensitive manner information from the different constituencies or entities that have an interest in disseminating specific, high quality and targeted information such as insurers, pharmacies, clinical laboratories or hospitals, as well as other distributors and product manufacturers, etc. As an example of one usage of the Medstory network, a patient who just interacted with healthcare providers (including, but not limited to, doctor visit, prescription, laboratory test, procedure, etc.) can receive targeted information from different sources. In one embodiment, the complex real-time aggregation of content and relevance determination are performed by the Medstory network, as well as the device-independent delivery mode. Thus, information and data that may be processed by the Medstory network include, but are not limited to, diagnostics, laboratory tests, prescriptions, medical or surgical procedure, genomic, genetic or molecular data, analysis or procedures, imaging results, practice profiles, disease or condition management information, pre-natal care, life style changes, practice profiles, utilization review and others.

In one embodiment, the information provided to the Medstory network may be pre-organized in, for example, but not limited to, insurance claims and prescription capture or database systems, electronic medical records, clinical databases, clinical trial databases or other health informatics solution.

The various sources of information that are distributed by the Medstory network may include, but are not limited to, content databases (e.g., web databases, wireless documents databases, etc.), clinical databases, medical records, imaging databases, test databases, genetic and genomic databases, molecular databases, business-oriented databases (e.g., referral policies, coverage policy bulletins, customer relationship management systems, etc.), publications, journals, bibliographic databases, and other information repositories or sources.

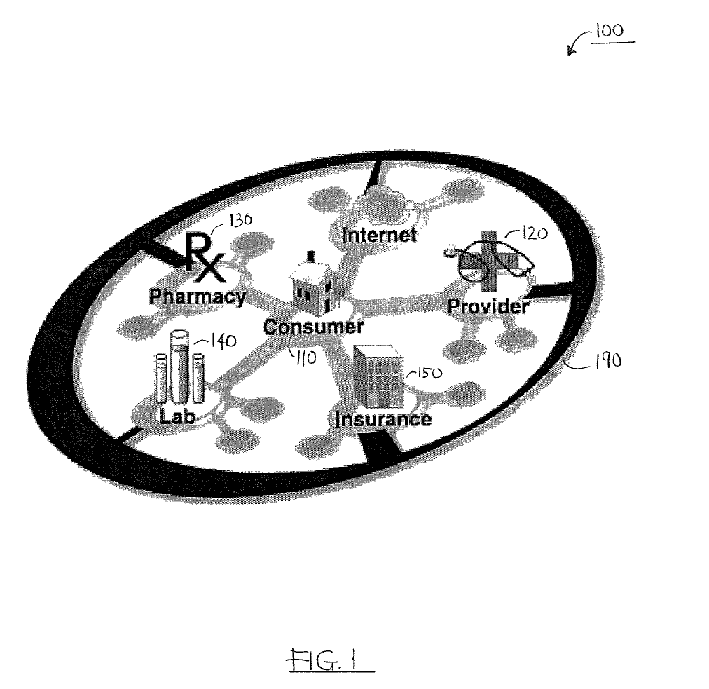

FIG. 1 illustrates a block diagram of one embodiment of a system in which various entities that are involved in the healthcare delivery chain can be connected to provide and obtain relevant healthcare information. As shown in FIG. 1, the various entities may include the healthcare consumers 110 (e.g., patients, etc.), the healthcare and service providers 120, pharmacies and pharmaceutical companies 130, laboratories 140, insurance companies 150, etc. that can be connected to share, retrieve, and distribute various types of health related information via the Medstory network 190. For example, each entity can contribute important and relevant information regarding the consumer's health episodes, lifestyle, or other health-related matters. In one embodiment, the Medstory network 190 is designed and configured to allow for the effective and efficient combination and distribution of information that are relevant to individual or clustered healthcare events.

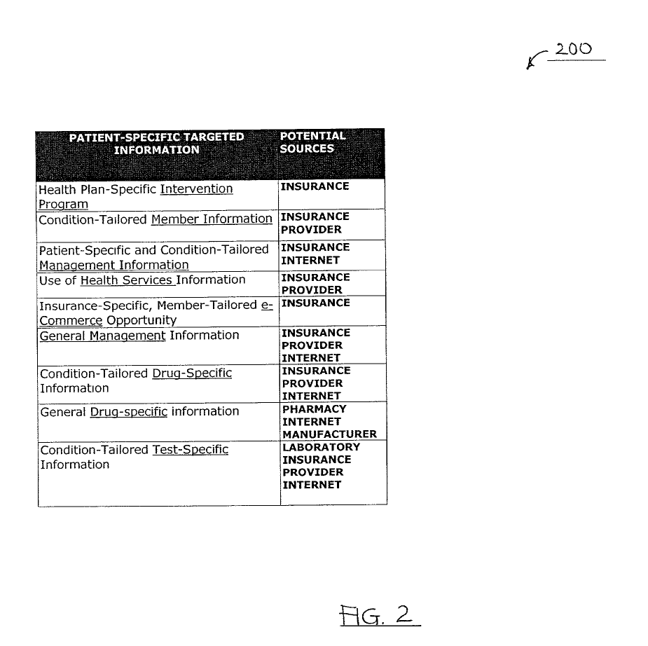

FIG. 2 shows an example of various types of information and their potential sources that may be of interest to healthcare consumers (e.g., patients. As shown in FIG. 2, the various types of information that may be of interest to the healthcare consumers may include information regarding health plan specific intervention program, patient-specific and condition-tailored management information, condition-tailored test-specific information, etc. In one embodiment, the various types of information illustrated in FIG. 1 may be stored in one or more databases at various locations or nodes that are connected to the Medstory network, as described in more details below.

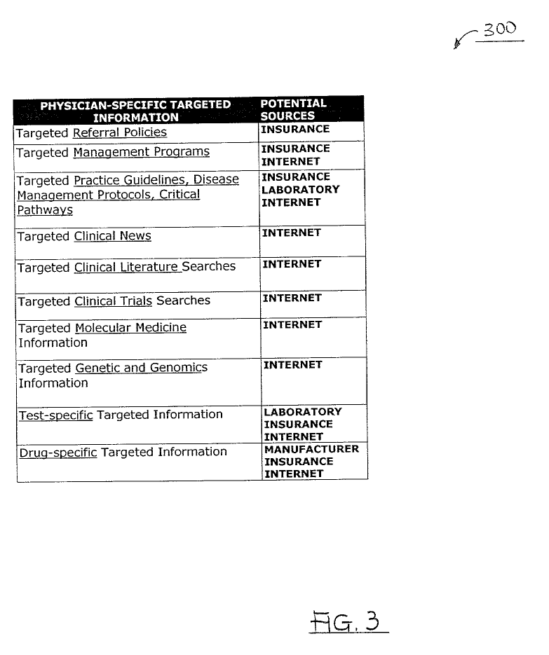

FIG. 3 illustrates an example of various types of information and their potential sources that may be of interest to healthcare providers (e.g., physicians). In this example, the various types of information that may be of interest to various healthcare providers may include targeted referral policies, targeted clinical news, test-specific targeted information, etc. In one embodiment, the various types of information illustrated in FIG. 1 may be stored in one or more databases at various locations or nodes that are connected to the Medstory network, as described in more details below.

It should be appreciated and understood by one skilled in the art that the various types of information included in FIGS. 2 and 3 are for the purposes of illustration and explanation and that other types of information and sources may be included within the scope of the present invention, depending on the applications and implementations of the present invention.

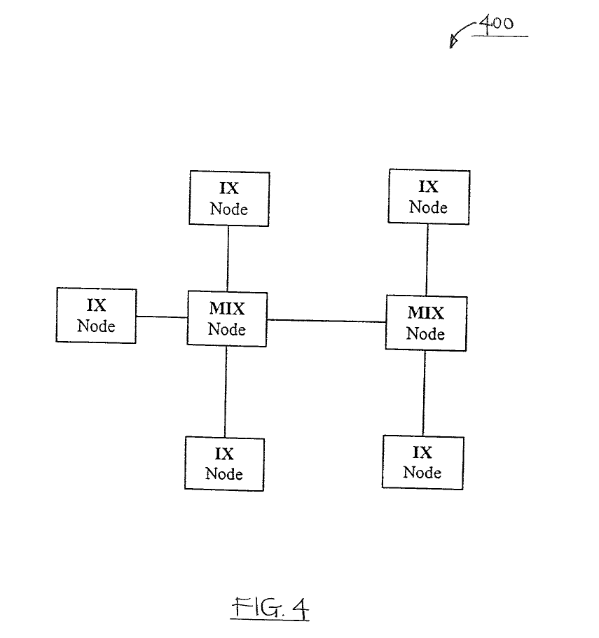

FIG. 4 shows a block diagram of a network 400 (also called the Medstory network herein) containing multiple nodes according to one embodiment of the present invention. In one embodiment, the Medstory network represents a new generation network that searches and discovers, aggregates and delivers targeted content and information from multiple and distributed sources. In one embodiment, the Medstory network is designed and configured to connect various organizations and portals, including Medstory corporate nodes. In one embodiment, a network node in the Medstory network can operate on any technology platform. As shown in FIG. 4, the network includes two types of nodes described for the purposes of explanation and illustration herein as “IX nodes” (Information eXchange nodes) and “MIX nodes” (Medstory Information exchange nodes). Hereinafter, IX nodes may also be referred to as nodes of first type and MIX nodes may also be referred to as nodes of second type or managing nodes. In one embodiment, IX nodes can correspond to sites, locations, or systems that are either producers or consumers of healthcare event data and corresponding targeted information. In one embodiment, MIX nodes can correspond to sites, locations, or systems that are configured to handle request distribution and response aggregation. In one embodiment, the MIX nodes may correspond to collation sites as well as data sources for managed reference data. In an alternative embodiment, there may exist one type of nodes that include functionality of both MIX and IX nodes as described herein.

Referring to FIG. 4, in one embodiment, IX nodes can only connect directly to MIX nodes while MIX nodes can connect directly to either IX nodes or MIX nodes. Thus, in one embodiment, the Medstory network has a topology of MIX nodes as hubs with IX nodes at the end of the spokes coming from the hubs, as illustrated in FIG. 4.

In one embodiment, a wide-area-network (WAN) implementation of the Medstory network can be done through any network protocol, for example, including but not limited to, leased, point-to-point connections or via VPN technologies through the Internet. In one embodiment, the bandwidth required between nodes can be configured to be directly related to the volume over time of transactions that need to be processed.

In one embodiment, the network as illustrated in FIG. 4 uses standard Internet protocols in both synchronous and asynchronous modes to communicate and process transactions. For example, HTTP, HTTPS, ebXML and SOAP are used for synchronous and asynchronous transactions, SMTP for asynchronous only transactions. Additional transport protocols could be used to transport the XML documents through the WAN as they become available.

In one embodiment, the majority of data passed between nodes may be XML documents that conform to two schemas: the request and response documents (which are also simply called requests and responses herein). These documents can be matched into pairs for each transaction.

In one embodiment, the request document may contain specific healthcare event information, usually coded, that is useful for determining the source and targeting of information relevant to the event. Some of the examples of events are lab requisitions, physician encounters, and prescriptions. For the purposes of illustration and explanation, shown below is a sample XML-based request document:

<REQUEST ID= D92UMA093JF302 Time=”20001019172500”>

<ORIGINATOR>

<ID>2454023</ID>
<NAME>HealthPlanYYY</NAME>
<TYPE>PHMO</TYPE>

</ORIGINATOR>
<EVENT TYPE=”LABREQ”>

<AGE>40Y0M0D</AGE>
<SEX>F</SEX>
<CONDITIONS>

<ICD9CM>V22</ICD9CM>

</CONDITIONS>
<PROCEDURES>

<CPT2001>84443</CPT2001>

</PROCEDURES>
<PROVIDER PRIMARY=HOSPITALXYZ DOCTOR=XXX>
<LOCATION STATE=CA ZIP=94404>

</EVENT>
<CATEGORIES>PATIENTINFO PATIENTQA</CATEGORIES>
<TUNERS>

<TUNER ID=KA102-2834 NAME=”ICD Intervention”>
<TUNER ID=QU100-1005 NAME=”Lab Request

Intervention”>

</TUNERS>

</REQUEST>

The request document shown in the example above, in one embodiment, could be formulated from a medical record contained in a healthcare provider's legacy system. In this example, it is assumed that Dr. XXX has ordered a lab requisition for a TSH test (the CPT2000 code for this test may be 84443) on a pregnant woman (the ICD9CM code for this condition may be V22.1), age 30. The request may also contain the authenticated ID of the originator of the document, time/date, and a unique network-wide identifier for the request. In one embodiment, this information may be authenticated by a corresponding MIX node through the VPN. In one embodiment, every request and response can have their delivery points authenticated by the MIX node.

In one embodiment, the request as shown in the above example would be processed first locally at the originating IX node, then forwarded to a corresponding MIX node (e.g., an MIX node to which the originating IX node is connected) for additional remote processing if necessary. In an alternative embodiment, a local system may originate a different request document and the local IX node then transforms the received request to a request that is understandable by the system. In one embodiment, the local IX node may add other service requests (via the addition of tuners) to the request document. In one embodiment, the processing of the request at the originating IX node and at additional nodes including the corresponding MIX node may be performed in parallel. In one embodiment, an additional request based on the original request can be created by the local originating IX node and sent to the corresponding MIX node for processing while the local database or service associated with the originating IX node is searched for targeted information.

Generally, the event related information included in the request such as event type and location may be sufficient to determine how the other event related information should be used to perform the necessary targeted searches. In this example, a lab requisition would specify that the CPT2001 code 84443, be used as a primary code for the search and the age, sex, and ICD9CM code V22.1 be used as contexts to further target the search. In one embodiment, the HMO and location of the event might dictate that additional information be obtained from a particular IX node (e.g., a Kaiser IX node) with the ICD9CM code as the primary code and the CPT2001, age, and sex as contextual information.

In one embodiment, various types parameters that are used to process requests including the prioritizing and filtering of targeted information described above are captured in a system object called a tuner. In one embodiment, each request can contain zero or more tuners that specify how to search the source database for targeted information. Generally, these tuners can be published by the information providers and allow them to specify what parameters are used for the search and what information categories are returned in the corresponding response document, etc. In one embodiment, various criteria can be used to categorize information. For example, these various criteria may include, but are not limited to, qualitative rankings, originating source or media type, etc. In the example illustrated above, a specific ICD intervention tuner (KA102-2834) is being requested that will use the ICD and CPT code to provide pregnancy (v22.2) intervention information to the patient and any supporting information on the TSH test. In one embodiment, the first 5 letters of the tuner may be used to identify the information source using a Medstory network unique identifier. In this case the information provider is the same as the healthcare service provider (e.g., HealthPlanYYY) so the information will be obtained through the requesting local IX node. The other tuner, QU100-1005, is a diagnostics company tuner that provides targeted information about the TSH test and where the patient's test, in this example, has been ordered. It will use the CPT code primarily and the ICD code, Age and Sex as further contextual information for the targeted search to return relevant intervention information for the patient. The tuner QU100-1005 can be associated with the IX node of the diagnostics company. Other tuners could be invoked in a different example, such as one calling for targeted information from a pharmaceutical or biotechnology company, an institution or any other source of information.

In one embodiment, the various tuners that are used to control the processing of requests may contain the following: the primary code type, the primary table, the secondary contexts to use for the search, categories of information to provide, filtering parameters and reference limits for each parameter, and final sorting parameters, etc. For explanation and illustration purposes, shown below is an XML representation of an exemplary tuner that can be used to handle lab requisition requests:

<TUNER ID=QU100-1005 NAME=”Lab Request Intervention”>

<PRIMARYCONTEXT>

<CONTEXT>CPT2000</CONTEXT>

</PRIMARYCONTEXT>
<TABLE>ICDREFERENCES</TABLE>
<CONTEXTS>

<CONTEXT>ICD9CM</CONTEXT>
<CONTEXT>AGE</CONTEXT>
<CONTEXT>SEX</CONTEXT>

<CONTEXTS>
<CATEGORIES>

<CATEGORY>PATIENTINFO</CATEGORY>
<CATEGORY>PATIENTQA</CATEGORY>

</CATEGORIES>
<FILTERS>

<PARAM>ORGANIZATION</PARAM>
<PARAM>RANK</PARAM>
<PARAM>MEDIATYPE</PARAM>

</FILTERS>
<ORDERBY PARAM=RANK ORDER=ASCENDING>
<ORDERBY PARAM=ORGANIZATION ORDER=ASCENDING>
<REFERENCELIMIT>6</REFERENCELIMIT>

</TUNER>

In one embodiment, tuners may be represented in an XML representation or they may be represented in some other form, such as in a format that is contained in a database. Tuners may be sent with a request or alternatively they may be kept locally at the node that retrieves the information.

In one embodiment, the requests (e.g., in XML representation) are routed through the network and processed at one or more nodes. Requests originate from an IX node or from a system (e.g., a web server) that has permission to make a request to an IX node. In one embodiment, each IX node maintains a list of systems that are allowed to make a request to that IX node.

In one embodiment, the results of the targeted search are returned in the form of a response document that may be in XML representation. In one embodiment, this document contains a set of references (URL's ) and associated contextual information in a well-structured XML document that can easily be aggregated with other response documents. Responses from multiple nodes are aggregated into a final response XML document that is delivered to the requester.

A sample response document is shown below:

<?xml version=”1.0” encoding=”UTF-8”?>
<response request=”null” status=”null”>
<header>

<priority>0</priority>
<sender>null</sender>
<timestamp>0</timestamp>

</header>
<tuners>

<tuner ID=”1234-4321” status=”not published” />
<tuner ID=”1000-1001” status=”ok” />
<tuner ID=”4444-4444” status=”not published” />

</tuners>
<links>

<link tuner=”1000-1001”>

<url>http://www.HealthPlanYYY.com/california/members/hbeat
/summer_hmo/page5.asp</url>

<topic>6</topic>
<publisher-type>10</publisher-type>
<reading-level>1</reading-level>
<quality>1</quality>
<format>1</format>

</link>

</links></response>

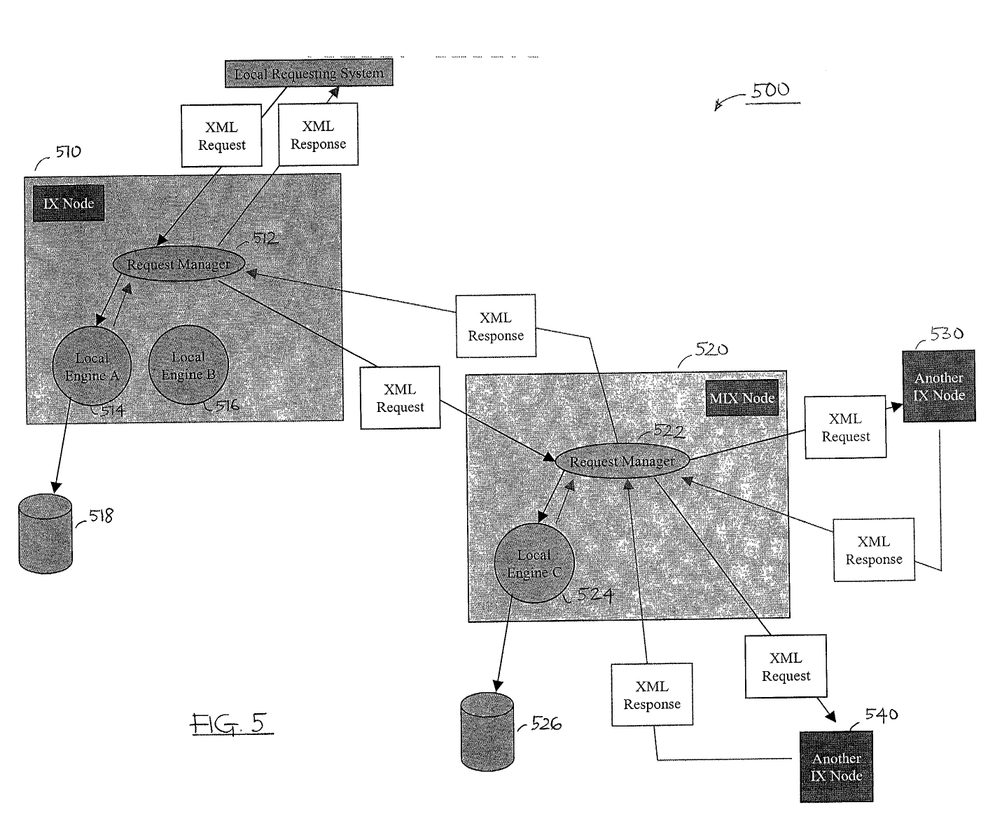

FIG. 5 illustrates a block diagram of one embodiment of a system 500 according to the teachings of the present invention. FIG. 5 shows the flow of information and the interactions between various components in handling of requests. As illustrated in FIG. 5, the system 500 includes several processing nodes including an IX node 510, an MIX node 520, and additional IX nodes 530 and 540. In one embodiment, the IX node 510 may include a corresponding request manager 512 and local engines 514 and 516 each may be used to search a database 518 associated with the IX node 510 for targeted and relevant information in response to requests received at the IX node 510. Similarly, in one embodiment, the MIX node 520 may include a request manager 522, one or more local engines such as local engine 524 that can be used to search a database 526 that is associated with the MIX node 520. In one embodiment, the additional IX nodes in the network or system 500 may include similar components for processing requests and responses as the IX node 510. As shown in FIG. 5, in one embodiment, each respective request manager is responsible for receiving and distributing requests and responses to the appropriate entities in the network. In one embodiment, the responses are generated through the system involving multiple IX nodes interacting with an MIX node. In this example, a request is generated by a local system 505 (e.g., a web portal), which sends the request to the local IX node 510. The IX node 510 is configured to handle the request locally and send the request to a corresponding MIX node (e.g., MIX node 520) for further processing and dispatching to the appropriate additional IX nodes (e.g., IX nodes if the request involves tuners that cannot be handled by the local IX node.

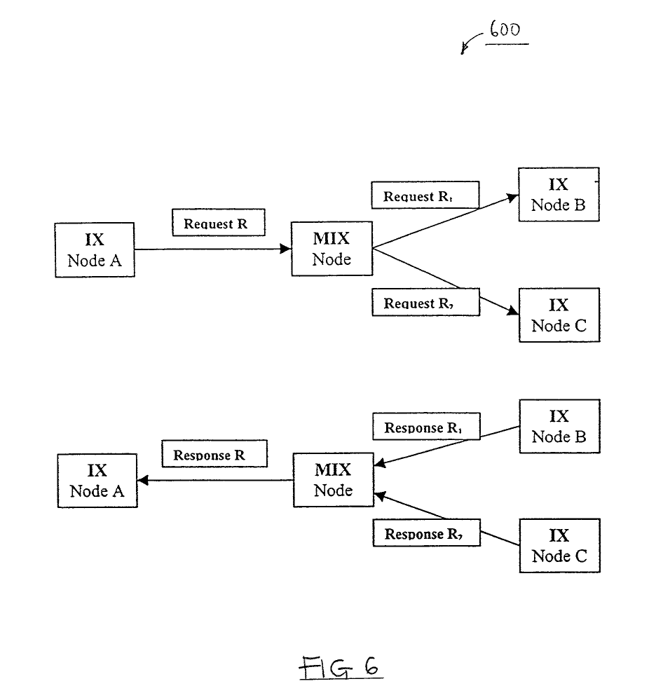

In one embodiment, local systems may interact with each other directly in a peer-to-peer setting where an IX node sends a request directly to another IX node. FIG. 6 illustrates the pathways of a request and a response as they are propagated through a system involving multiple IX nodes interacting with an MIX node. As illustrated in FIG. 6, a request R that is received and processed at an IX node (e.g., node A) can be propagated or sent to a corresponding MIX node. In one embodiment, the MIX node can further process the request to obtain targeted and relevant information from one or more databases associated with the MIX node. In addition, the MIX node can create new requests based on the request received from node A and forward the new requests to the appropriate additional IX nodes (e.g., node B and node C in this example) to obtain information from the databases associated with the additional IX nodes. In this example, the MIX node creates a new request R1 that is sent to IX node B and a new request R2 that is sent to IX node C. As described in more details below, IX node B and IX node C, after processing their respective requests, send the respective responses R1 and R2 back to the MIX node. In one embodiment, the MIX node aggregates the responses received from IX nodes B and C with a response generated at the MIX node and send the aggregated response R back to IX node A.

### IX Nodes

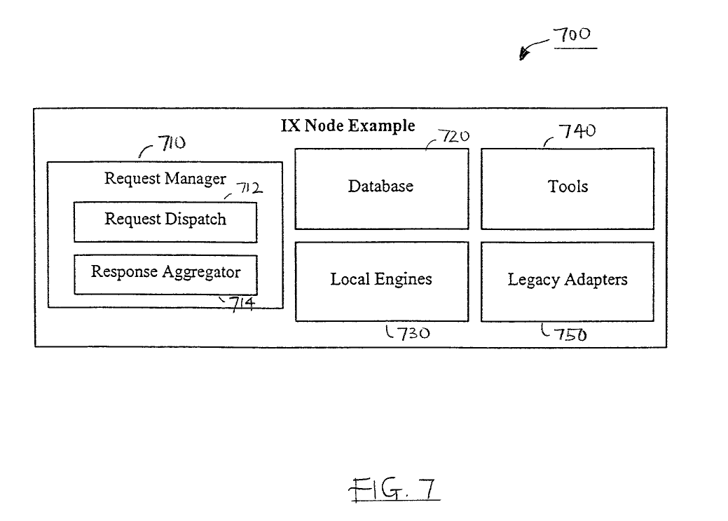

In one embodiment, an IX node includes a database plus other components that enable the processing of targeted requests. FIG. 7 illustrates a block diagram of one embodiment of an IX node structure 700 in accordance with the teachings of the present invention. As shown in FIG. 7, an IX node typically may include a request manager 710 that is responsible for handling request dispatch and response aggregation. The request manager 710, in one embodiment, includes a request dispatch unit 712 and a response aggregator unit 714. In one embodiment, the IX node 700 further includes one or more local databases 720, one or more local engines 730, a set of tools 740 that can be used for system configuration and/or system administration, and legacy adapters 750 to interface with legacy systems.

In one embodiment, IX nodes are licensed to customers or providers that want to provide information the other node customers in the Medstory network. They may have indexed customer information that is created and maintained by the customer. In one embodiment, the information is indexed into a set of database tables that can be searched by one or more engines that are components of the IX node, as described in patent application Ser. No. 09/591,769 filed Jun. 12, 2000, entitled “Method, Apparatus, and System for Providing Health Information”, which claims the benefit of U.S. Provisional Application No. 60/140,102 filed Jun. 18, 1999. In one embodiment, each engine can be specialized to search on particular type of source information. In one embodiment, the behavior of the engine including, for example, how it searches the database, filters information, and sorts the information, is controlled by a corresponding tuner.

In one embodiment, each tuner may have a one-to-one relationship with an engine. Each IX node that is capable of processing requests locally uses one or more engine components. These engines are not to be confused with the textual search engines currently used to power most web sites. As described herein and in the related patent application Ser. No. 09/591, 769 filed Jun. 12, 2000, these engines which are components of IX nodes can be tuned or configured to return a targeted set of information that is relevant for a particular healthcare event or interaction using sophisticated sets of database join operations on a set of tables. In one embodiment, the results of these operations are a set of references that target the event and have been filtered and ordered according to the tuner used.

In one embodiment, tools are provided that enable the creation and modification of tuner parameters at each IX node. In one embodiment, the tools allow the information source provider at the IX node to control what content is sent from the IX node to the rest of the network. For example, the XYZ Diagnostics company IX node that provides targeted information for customer laboratory requests could configure a tuner to just provide patient information intervention or clinical trial information and nothing else, even if other information in the database also targets the specific healthcare event. In one embodiment, there is no limit on how many tuners can be created and made available to other nodes on the network.

Each request can have one or more tuners associated with it. In one embodiment, the requester has the option to specify tuners or let the local IX and/or MIX node determine what tuners are appropriate for the request. In one embodiment, the tuners are carried with the request and processed at the appropriate locations. Each IX node will run the appropriate engine for a particular tuner and merge the results into a response object or response document that is sent back to the corresponding MIX node, as shown in FIG. 6 above. In one embodiment, MIX nodes are responsible for aggregating results from multiple IX nodes. The final response is transmitted in the form of a response document that is transmitted back to the originating IX node. The response document will contain the references that have been aggregated by the MIX node and from tuners run against the Medstory central database (at the MIX node). In one embodiment, the originating IX node will then merge any local tuner references into the final response object or response document that can be used by any third party portal system to present the reference information to a user (e.g., a consumer or a physician).

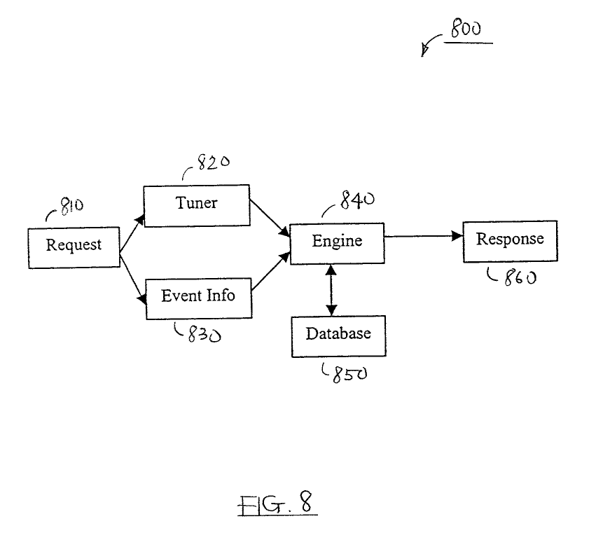

FIG. 8 illustrates a block diagram showing interactions between various components in processing a request to generate a corresponding response, according to the teachings of the present invention. As shown in FIG. 8, a request 810 may include tuner information 820 and event information 830 that can be used to determine one or more particular engines 840 that are used to search one or more databases 850 to retrieve relevant and targeted information based on the information contained in the request to generate a response 860.

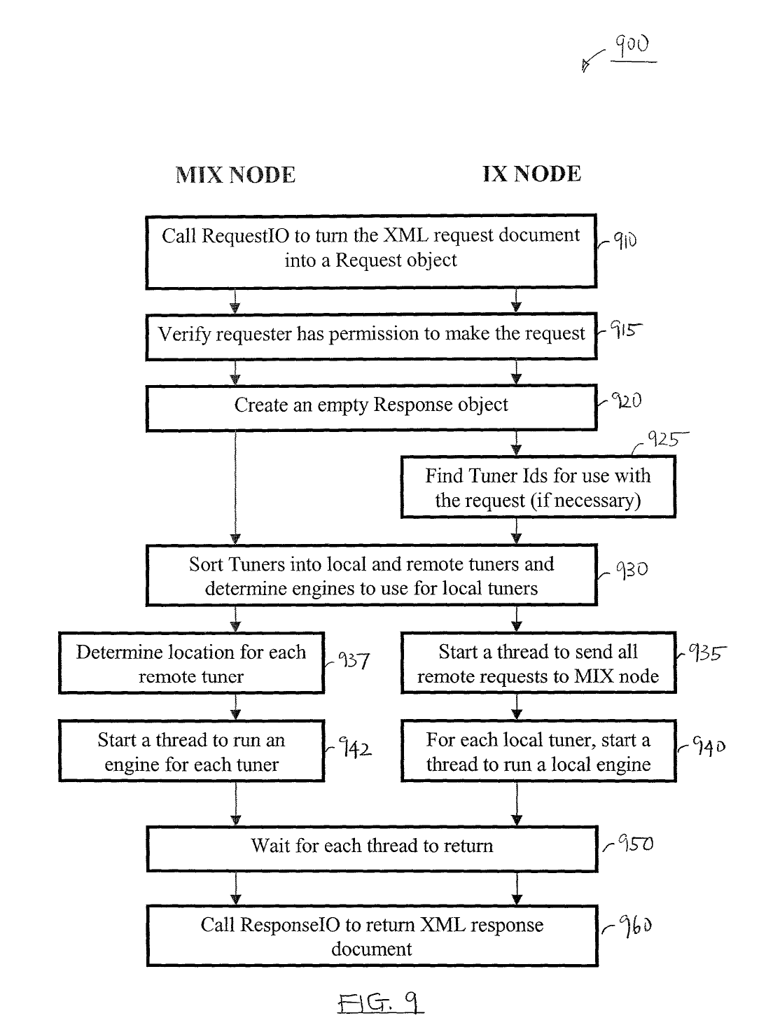

FIG. 9 shows a flow diagram of one embodiment of a process performed by an IX node in processing a request. At block 910, requestIO module is called to turn the XML request document into a request object. At block 915, a verification is made to verify that the requester has permission to make the request. At block 920, an empty response object is created. At block 925, if necessary, find the tuner IDs for use with the request, based on the information contained in the request. At block 930, tuners are sorted into local and remote tuners and the appropriate engines are determined to use for local tuners. At block 935, a thread is started at the respective IX node to send all remote requests (requests containing remote tuners) to a corresponding MIX node (e.g., an MIX node to which the respective IX node is configured to use). At block 940, for each local tuner, a thread is started to run a corresponding local engine to search one or more corresponding local databases. At block 950, the respective IX node waits for each thread to return. At block 960, call responseIO to return the response document.

In one embodiment, the IX request process flow can be summarized as follows:

In one embodiment, the event parameters (also called even information, e.g., sxtype, location, HMO, etc.) can be optionally used to determine what local tuners are appropriate for the request. In one embodiment, these tuners are added to any tuners already specified in the request. In one embodiment, duplicate tuners are removed.

In one embodiment, as described herein, local tuners are processed at the respective IX node (e.g., running the appropriate local engines associated with these local tuners to search the associated database(s) for relevant and targeted information for the respective request.

In one embodiment, the request can be dispatched from the respective IX node to a corresponding MIX (e.g., the connected MIX node) for further processing. In one embodiment, the MIX node dispatches requests to the appropriate additional IX nodes for processing of the request with respect to remote tuners. For example, if the request contains a remote tuner YYY that can be handled by IX node B and another remote tuner ZZZ that can be handled by IX node C, then the MIX node can create a new request R1 containing the remote tuner YYY that is sent to IX node B and another new request R2 containing the remote tuner ZZZ that is sent to IX node C.

The IX node then waits for the MIX response.

Upon receiving the response from the MIX node, the local response generated at the respective IX node is aggregated with response from MIX node (the response from the MIX node also represents responses from the other additional IX nodes in aggregated form).

The aggregate response is sent to the originator of the request.

### MIX Nodes

FIG. 9 also shows a flow diagram of one embodiment of a process performed by an MIX node in processing a request. At block 910, requestIO module is called to turn the XML request document into a request object. At block 915, a verification is made to verify that the requester has permission to make the request. At block 920, an empty response object is created. At block 930, tuners are sorted into local and remote tuners and the appropriate engines are determined to use for local tuners. At block 937, a location (IX node) for each remote tuner is determined. At block 942, a thread is started to run an engine for each tuner. At block 950, the respective MIX node waits for each thread to return. At block 960, call responseIO to return the response document.

In one embodiment, an MIX node operates differently from IX nodes in two significant ways:

In one embodiment, one of the differences between an IX node and an MIX node is how their Request Managers dispatch remote requests. In an IX node, all tuner IDs that are not found locally are sent with the original request parameters to an MIX node. An MIX node, on the other hand, is able to determine the location (IX node) that handles any published tuner, and dispatches individual requests each with the single tuner ID to each determined location (IX node).

In one embodiment, local requesting systems (e.g., web servers) are allowed to issue requests to their local IX node without specifying which tuner(s) to use for the request. The IX node will then generate a list of tuners to use for the request, based on the information contained in the request (e.g., event information). On the other hand, requests received by MIX nodes without any tuner IDs are considered invalid requests.

In one embodiment, an MIX node is very similar in architecture to an IX node except for the following added capabilities:

In one embodiment, an MIX node is configured to validate all requests coming from IX nodes. In one embodiment, an MIX node uses IP address translation table to confirm the network ID of the request source.

In one embodiment, an MIX node contains tuner translation tables for the entire network to determine to which nodes a particular request should be dispatched.

In one embodiment, an MIX node is also configured to maintain a central log of all network transactions.

Upon receiving a request from an IX node, the MIX node process flow in one embodiment can be summarized as follows:

In one embodiment, the MIX node authenticates the originating IP address of the request IX node and translates it into a network unique node ID. The node ID is inserted into the request.

In one embodiment, the MIX node also can use the event parameters or event information (e.g., event type, location, HMO, etc.) to determine what tuners are appropriate for the request. In one embodiment, these tuners are added to any tuners already specified in the request. In one embodiment, duplicate tuners are removed.

Process tuners that are specific to Medstory network (e.g., tuners that are designated for Medstory corporate nodes).

Group the tuners by network node (except for tuners belonging to the originating IX node).

Create a new request for each group of tuners.

Dispatch the new request to the corresponding IX node for the respective tuner group.

Wait for response from each IX node to which a new request is sent.

Aggregate responses from each IX or MIX node and from any Medstory tuner responses.

Send aggregate response to originating IX node.

In one embodiment, the MIX node is not the final destination for a response document. Instead, response documents that the MIX node receives are forwarded to the originating IX node that issues the request. In one embodiment, MIX nodes are not responsible for originating a request and MIX nodes are not the final destination of a response. Thus, in one embodiment, MIX nodes can fulfill an important routing and processing function that allows controlled communication between IX nodes in the network.

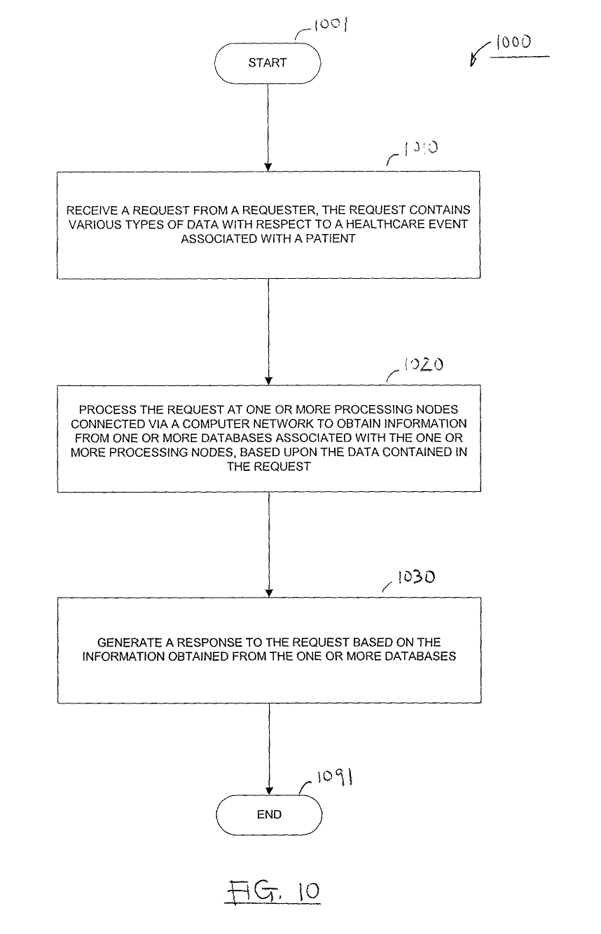

FIG. 10 shows a flow diagram of one embodiment of a method 1000 in accordance with the teachings of the present invention. At block 1010, a request is received from a requester. In one embodiment, the request may contain various types of data with respect to a healthcare event associated with a patient. At block 1020, the request is processed at one or more processing nodes connected via a computer network to obtain information for the request, based on the data contained in the request. At block 1030, a response document is generated based on the information obtained from the one or more processing nodes in the network.

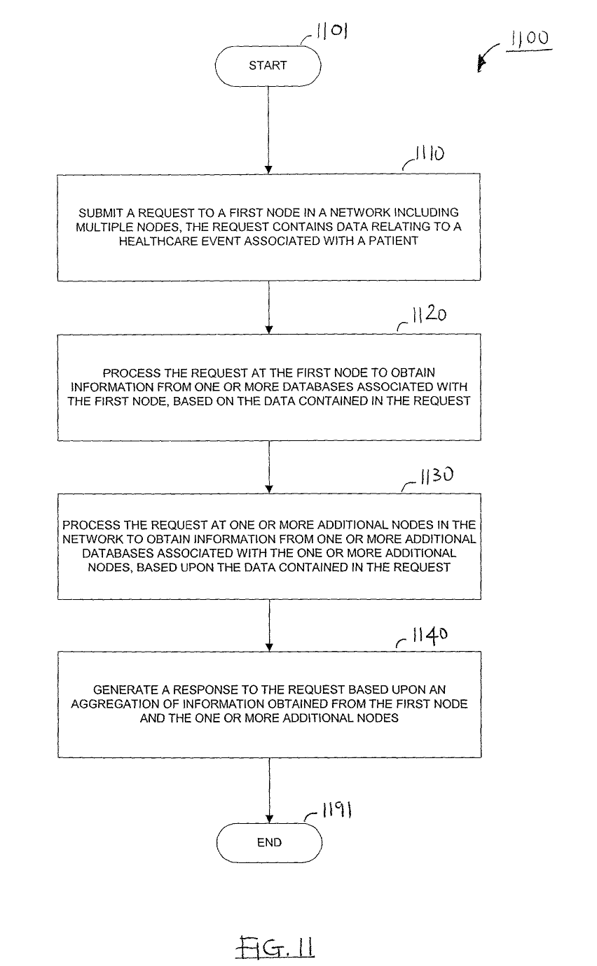

FIG. 11 shows a flow diagram of one embodiment of a method 1100 according to the teaching of the present invention. At block 1110, a request is submitted to a first node (e.g., an IX node) in a network that includes multiple nodes. In one embodiment, the request contains data relating to a healthcare event associated with a healthcare consumer (e.g., a patient). At block 1120, the request is processed at the first node to obtain information from one or more databases associated with the first node, based upon the data contained in the request. At block 1130, the request is processed at one or more additional nodes in the network to obtain information from one or more databases associated with the one or more additional nodes, based upon the data contained in the request. At block 1140, a response to the request is generated based upon an aggregation of information obtained from the first node and the one or more additional nodes.

The invention has been described in conjunction with the preferred embodiment. It is evident that numerous alternatives, modifications, variations and uses will be apparent to those skilled in the art in light of the foregoing description. Although the invention has been described with reference to specific exemplary embodiments, it will be evident that various modifications and changes may be made to these embodiments without departing from the broader spirit and scope of the invention. Accordingly, the specification and drawings are to be regarded in an illustrative sense rather than a restrictive sense.

What is claimed is:

1. A method comprising:
receiving a request from a requester containing data relating to a healthcare event associated with a patient;
processing the request at one or more processing nodes connected via a computer network to obtain information from one or more databases associated with the one or more processing nodes, based upon the data contained in the request; and
generating a response to the request based upon the information obtained from the one or more databases associated with the one or more processing nodes.

2. The method of claim 1 further including:
delivering the response to the requester.

3. The method of claim 1 wherein the data contained in the request include an event type corresponding to the healthcare event.

4. The method of claim 1 wherein the data contained in the request include data identifying the requester.

5. The method of claim 1 wherein the data contained in the request include data about a medical procedure performed for the patient.

6. The method of claim 5 wherein the data about the medical procedure include one or more procedure codes indicating the medical procedure performed for the patient.

7. The method of claim 6 wherein the one or more procedure codes include procedure codes according to the Current Procedure Terminology (CPT).

8. The method of claim 6 wherein the one or more procedure codes include procedure codes according to the International Classification of Disease (ICD).

9. The method of claim 1 wherein the data contained in the request include data about the patient including diagnosis information based upon a diagnosis of the patient.

10. The method of claim 9 wherein the diagnosis information include one or more diagnosis codes indicating one or more conditions of the patient based upon the diagnosis.

11. The method of claim 1 wherein information obtained from the one or more databases includes one or more data sources, and wherein a data source is referenced by an address corresponding to a location where the respective data source resides.

12. The method of claim 1 wherein the address corresponding to the location where the data source resides includes a Uniform Resource Locator (URL).

13. The method of claim 1 wherein the data contained in the request include one or more identifiers each corresponding to a set of parameters that are used for processing the respective request.

14. The method of claim 13 wherein each identifier corresponds to a system object that is used to store the corresponding set of parameters used to process the request.

15. The method of claim 1 wherein processing the request includes:
processing the request at a local processing node which is designated to process requests originated by a particular requesting system associated with the requester.

16. The method of claim 15 further including:
processing the request at one or more remote processing nodes being connected to the local processing node via a computer network.

17. The method of claim 16 wherein the processing of the request at the local processing node and the processing of the request at one or more remote processing nodes are performed in parallel.

18. The method of claim 1 wherein processing the request at the one or more processing nodes includes:
searching the one or more databases at the one or more processing nodes to retrieve a list of data sources matching a set of search criteria constructed based upon the data contained in the request.

19. The method of claim 1 wherein generating the response includes:
aggregating the information obtained from the one or more processing nodes to produce the response.

20. A method comprising:
submitting a request to a first node in a network containing multiple nodes, the request containing data relating to a healthcare event associated with a patient;
processing the request at the first node to obtain information from one or more databases associated with the first node, based upon the data contained in the request;
processing the request at one or more additional nodes in the network to obtain information from one or more additional databases associated with the one or more additional nodes, based upon the data contained in the request; and
generating a response to the request based upon an aggregation of information obtained from the first node and the one or more additional nodes.

21. The method of claim 20 further including:
delivering the response to a requester that originates the request.

22. The method of claim 20 wherein the data relating to the healthcare event include an event type and location corresponding to the healthcare event.

23. The method of claim 20 wherein the data relating to the healthcare event include data identifying the requester.

24. The method of claim 20 wherein the data relating to the healthcare event include data about a medical procedure performed for the patient.

25. The method of claim 24 wherein the data about the medical procedure include one or more procedure codes indicating the medical procedure performed for the patient.

26. The method of claim 20 wherein the data relating to the healthcare event include diagnosis information based upon a diagnosis of the patient.

27. The method of claim 26 wherein the diagnosis information include one or more diagnosis codes indicating one or more conditions of the patient based upon the diagnosis.

28. The method of claim 20 wherein the data contained in the request include data corresponding to one or more sets of parameters each being used to control the processing of the respective request.

29. The method of claim 20 wherein processing the request at the first node includes:
determining one or more sets of parameters to be used for processing the request at the first node; and
running one or more search engines associated with the one or more sets of parameters at the first node to retrieve information from the one or more databases associated with the first node.

30. The method of claim 29 wherein the one or more sets of parameters are determined based upon one or more identifiers contained the in the request.

31. The method of claim 29 wherein the one or more sets of parameters are determined based upon the data relating to the healthcare event contained in the request.

32. The method of claim 29 further including:
generating a response based on the information retrieved from the one or more databases associated with the first node.

33. The method of claim 20 wherein processing the request at the one or more additional nodes in the network includes:
sending the request from the first node to a corresponding managing node in the network; and
processing the request at the corresponding managing node to obtain information from one or more databases associated with the managing node.

34. The method of claim 33 wherein processing the request at the corresponding managing node includes:
determining one or more sets of parameters to be used for processing the request at the managing node; and
running one or more search engines associated with the one or more sets of parameters at the managing node to retrieve information from the one or more databases associated with the managing node.

35. The method of claim 34 further including:
identifying, for each set of parameters determined, a corresponding additional node in the network which is configured to handle the processing of the request based on the respective set of parameters; and
for each additional node identified, dispatching a new request to the corresponding additional node, the new request being generated based on the request received at the managing node and including data corresponding to the respective set of parameters.

36. The method of claim 35 further including:
processing the new request at the corresponding additional node in the network to obtain information from one or more databases associated with the corresponding additional node; and
returning the information obtained from the corresponding additional node to the managing node.

37. The method of claim 36 further including:
aggregating information returned from additional nodes at the managing node to generate an aggregated response for the managing node; and
sending the aggregated response to the first node.

38. The method of claim 37 further including:
upon receiving the aggregated response from the managing node, aggregating the response generated at the first node with the aggregated response received from the managing node.

39. A system comprising:
a first processing node to process requests originated by a first requester to generate a first response for each request based on information obtained from one or more databases associated with the first processing node; and
a second processing node connected to the first processing node, the second processing node to process each request forwarded from the first processing node to generate a second response for each request based on information obtained from one or more databases associated with the second node and to send the second response back to the first processing node,
wherein the first processing node, upon receiving the second response from the second processing node, aggregates the first response and the second response to generate an aggregated response for each respective request.

40. The system of claim 39 wherein each request contains a set of data used by the respective processing node to search the one or more associated databases to obtain information in response to the respective request.

41. The system of claim 40 wherein the set of data contained in the respective request includes a first subset of data relating to a healthcare event associated with a patient.

42. The system of claim 41 wherein the first subset of data includes data about a medical procedure performed for the patient.

43. The system of claim 41 wherein the data about the medical procedure include one or more procedure codes corresponding to the medical procedure performed.

44. The system of claim 41 wherein the first subset of data includes the patient's diagnosis data.

45. The system of claim 44 wherein the diagnosis data include one or more diagnosis codes corresponding to one or more conditions of the patient.

46. The system of claim 40 wherein the set of data contained in the respective request includes a second subset of data corresponding to one or more sets of parameters used to control the processing of the respective request.

47. The system of claim 46 wherein the data contained in the respective request are used to determine the one or more sets of parameters used to control the processing of the respective request.

48. The system of claim 47 wherein each set of parameters is stored in a corresponding system object.

49. The system of claim 48 wherein the first processing node includes one or more search engines each configured to process requests associated with one or more particular system objects.

50. The system of claim 49 wherein the first processing node includes one or more databases and wherein each search engine is configured to search the one or more databases to obtain information for the respective request, based on the set of parameters associated with the respective request.

51. The system of claim 50 wherein the second processing nodes includes one or more search engines each configured to process requests associated with one or more particular system objects.

52. The system of claim 39 wherein the second processing node is configured to identify and dispatch a new request based upon each request received from the first processing node to a corresponding additional processing node, the corresponding additional processing node being configured to handle the processing of the new request based on one or more particular set of parameters associated with the new request as determined based on data contained in the new request.

53. The system of claim 52 wherein the additional processing node includes one or more search engines and one or more databases, each search engine being configured to search the one or more databases to obtain information for the respective new request received from the second processing node, based upon the set of parameters associated with the respective new request.

54. The system of claim 53 wherein the additional processing node returns a response for the respective new request to the second processing node, the second processing node aggregates the response received from the additional processing node with the response generated by the second processing node and returns the aggregated response to the first processing node.

55. A machine-readable medium comprising instructions which, when executed by a machine, cause the machine to perform operations including:
receiving a request from a requester containing data relating to a healthcare event associated with a patient;
processing the request at one or more processing nodes connected via a computer network to obtain information from one or more databases associated with the one or more processing nodes, based upon the data contained in the request; and
generating a response to the request based upon the information obtained from the one or more databases associated with the one or more processing nodes.

56. The machine-readable medium of claim 55 further including:
delivering the response to the requester.

57. The machine-readable medium of claim 56 wherein the data contained in the request include an event type corresponding to the healthcare event.

58. The machine-readable medium of claim 55 wherein the data contained in the request include data identifying the requester.

59. The machine-readable medium of claim 55 wherein the data contained in the request include data about a medical procedure performed for the patient.

60. The machine-readable medium of claim 59 wherein the data about the medical procedure include one or more procedure codes indicating the medical procedure performed for the patient.

61. The machine-readable medium of claim 55 wherein the data contained in the request include data about the patient including diagnosis information based upon a diagnosis of the patient.

62. The machine-readable medium of claim 61 wherein the diagnosis information include one or more diagnosis codes indicating one or more conditions of the patient based upon the diagnosis.

63. The machine-readable medium of claim 55 wherein the data contained in the request include one or more identifiers each corresponding to a set of parameters that are used for processing the respective request.

64. The machine-readable medium of claim 55 wherein processing the request includes:
processing the request at a local processing node which is designated to process requests originated by a particular requesting system associated with the requester.

65. The machine-readable medium of claim 64 further including:
processing the request at one or more remote processing nodes connected to the local processing node via a computer network.

66. The machine-readable medium of claim 65 wherein the processing of the request at the local processing node and the processing of the request at one or more remote processing nodes are performed in parallel.

67. The machine-readable medium of claim 65 wherein processing the request at the one or more processing nodes includes:
searching one or more databases at the one or more processing nodes to retrieve a list of data sources matching a set of search criteria constructed based upon the data contained in the request.

68. The machine-readable medium of claim 55 wherein generating the response includes:
aggregating the information obtained from the one or more processing nodes to produce the response.

69. A machine-readable medium comprising instructions which, when executed by a machine, cause the machine to perform operations including:
submitting a request to a first node in a network containing multiple nodes, the request containing data relating to a healthcare event associated with a patient;
processing the request at the first node to obtain information from one or more databases associated with the first node, based upon the data contained in the request;
processing the request at one or more additional nodes in the network to obtain information from one or more additional databases associated with the one or more additional nodes, based upon the data contained in the request; and
generating a response to the request based upon an aggregation of information obtained from the first node and the one or more additional nodes.

70. The machine-readable medium of claim 69 further including:
delivering the response to a requester that originates the request.

71. The machine-readable medium of claim 69 wherein the data relating to the healthcare event include an event type and location corresponding to the healthcare event.

72. The machine-readable medium of claim 69 wherein the data relating to the healthcare event include data about a medical procedure performed for the patient.

73. The machine-readable medium of claim 72 wherein the data about the medical procedure include one or more procedure codes indicating the medical procedure performed for the patient.

74. The machine-readable medium of claim 69 wherein the data relating to the healthcare event include diagnosis information based upon a diagnosis of the patient.

75. The machine-readable medium of claim 74 wherein the diagnosis information include one or more diagnosis codes indicating one or more conditions of the patient based upon the diagnosis.

76. The machine-readable medium of claim 69 wherein the data contained in the request include data corresponding to one or more set of parameters each being used to control the processing of the respective request.

77. The machine-readable medium of claim 76 wherein processing the request at the first node includes:
determining one or more sets of parameters to be used for processing the request at the first node; and
running one or more search engines associated with the one or more sets of parameters at the first node to retrieve information from the one or more databases associated with the first node.

78. The machine-readable medium of claim 77 wherein the one or more sets of parameters are determined based upon one or more identifiers contained the in the request.

79. The machine-readable medium of claim 77 wherein the one or more sets of parameters are determined based upon the data relating to the healthcare event contained in the request.

80. The machine-readable medium of claim 77 further including:
generating a response based on the information retrieved from the one or more databases associated with the first node.

81. The machine-readable medium of claim 69 wherein processing the request at the one or more additional nodes in the network includes:
sending the request from the first node to a corresponding managing node in the network; and
processing the request at the corresponding managing node to obtain information from one or more databases associated with the managing node.

82. The machine-readable medium of claim 81 wherein processing the request at the corresponding managing node includes:
determining one or more sets of parameters to be used for processing the request at the managing node; and
running one or more search engines associated with the one or more sets of parameters at the managing node to retrieve information from the one or more databases associated with the managing node.

83. The machine-readable medium of claim 82 further including:
identifying, for each set of parameters determined, a corresponding additional node in the network which is configured to handle the processing of the request based on the respective set of parameters; and
for each additional node identified, dispatching a new request to the corresponding additional node, the new request being generated based on the request received at the managing node and including data corresponding to the respective set of parameters.

84. The machine-readable medium of claim 83 further including:
processing the new request at the corresponding additional node in the network to obtain information from one or more databases associated with the corresponding additional node; and
returning the information obtained from the corresponding additional node to the managing node.

85. The machine-readable medium of claim 84 further including:
aggregating information returned from additional nodes at the managing node to generate an aggregated response for the managing node; and
sending the aggregated response to the first node.

86. The machine-readable medium of claim 85 further including:
upon receiving the aggregated response from the managing node, aggregating the response generated at the first node with the aggregated response received from the managing node.
